(19) United States
(12) Patent Application Publication
(10) Pub. No.: US 2012/0218245 A1
(43) Pub. Date: Aug. 30, 2012

(54) LIQUID CRYSTAL DISPLAY DEVICE AND METHOD OF DRIVING THE SAME

(75) Inventors: Hideki Morii, Osaka-shi (JP); Akihisa Iwamoto, Osaka-shi (JP); Takayuki Mizunaga, Osaka-shi (JP); Yuuki Ohta, Osaka-shi (JP)

(73) Assignee: SHARP KABUSHIKI KAISHA, Osaka-shi, Osaka (JP)

(21) Appl. No.: 13/501,151

(22) PCT Filed: Aug. 27, 2010
(86) PCT No.: PCT/JP2010/064559

§ 371 Date: Apr. 10, 2012

(30) Foreign Application Priority Data
Nov. 4, 2009 (JP) 2009-252725

(51) Int. Cl. G09G 5/00; G09G 3/36

(52) U.S. Cl. 345/211; 345/87

(57) ABSTRACT

A liquid crystal display device includes a monolithic gate driver capable of quickly eliminating residual charges within pixel formation portions when the power-supply is turned off. Each of bistable circuits that constitute a shift register within a gate driver is provided with a thin-film transistor having a drain terminal connected to a gate bus line, a source terminal connected to a reference potential line for transmitting a reference potential, and a gate terminal to which a clock signal for operating the shift register is supplied. When the external supply of power-supply voltage is cut off, the clock signal is set to high level to turn the thin-film transistor to the ON state, and the level of the reference potential is increased from a gate-OFF potential to a gate-ON potential.

### TECHNICAL FIELD

The present invention relates to a liquid crystal display device having a monolithic gate driver and a method of driving the same.

### BACKGROUND ART

Typically, an active matrix-type liquid crystal display device is provided with a liquid crystal panel that includes two substrates with a liquid crystal layer interposed therebetween. On one of the two substrates, a plurality of gate bus lines (scanning signal lines) and a plurality of source bus lines (video signal lines) are arranged in matrix, and a plurality of pixel formation portions arranged in matrix respectively corresponding to intersections between the plurality of gate bus lines and the plurality of source bus lines are provided. Each pixel formation portion includes such as a thin-film transistor (TFT) as a switching element having a gate terminal connected to the gate bus line that passes through the corresponding intersection and a source terminal connected to the source bus line that passes through this intersection, and a pixel capacitance for storing a pixel value. Further, the other of the two substrates is provided with a common electrode that is an opposite electrode provided so as to be shared by the plurality of pixel formation portions. The active matrix-type liquid crystal display device is also provided with a gate driver (scanning signal line drive circuit) for driving the plurality of gate bus lines and a source driver (video signal line drive circuit) for driving the plurality of source bus lines.

Although video signals indicating pixel values are transmitted through the source bus lines, the source bus lines cannot transmit video signals indicating pixel values for more than one line at the same time (simultaneously). Therefore, the video signals are written sequentially line by line to the pixel capacitances in the pixel formation portions arranged in matrix. Accordingly, the gate driver is configured by a shift register having a plurality of stages so that the plurality of gate bus lines are sequentially selected for a predetermined period.

In such a liquid crystal display device, there is often a case in which the display is not immediately cleared and an image such as a residual image remains even when the user has turned the power off. This is because a pathway to discharge the charges stored in the pixel capacitances is blocked when the power of the device is turned off, and residual charges are accumulated in the pixel formation portions. Further, turning the power of the device on while the residual charges are accumulated in the pixel formation portions may cause deterioration of visual quality such as occurrence of flickers due to biased impurities resulting from the residual charges.

Then, as the techniques to reduce accumulation of residual charges by power-off, there have been proposed various techniques as described below. Japanese Unexamined Patent Application Publication No. 2004-45785 discloses an invention of a liquid crystal display device allowing residual charges within all pixel formation portions to be discharged by setting all gate bus lines to a selected state (ON state) when the power is turned off. Published International Application No. WO 2007/007768 discloses an invention of a liquid crystal display device allowing a gate-OFF potential (potential of a signal to be supplied to a gate terminal of a switching element within a pixel formation portion when the switching element is turned off) to quickly reach the ground potential when the power is turned off. Japanese Unexamined Patent Application Publication No. 2007-11346 discloses an invention of a liquid crystal display device designed for reducing duration of discharge of residual charges by increasing the gate-OFF potential to be higher than the ground potential when the power is turned off.

### PRIOR ART DOCUMENTS

### Patent Documents

[Patent Document 1] Japanese Unexamined Patent Application Publication No. 2004-45785

[Patent Document 2] Published International Application No. WO 2007/007768

[Patent Document 3] Japanese Unexamined Patent Application Publication No. 2007-11346

### SUMMARY OF THE INVENTION

### Problems to be Solved by the Invention

In recent years, in a liquid crystal display device employing an a-Si TFT liquid crystal panel (a liquid crystal panel using amorphous silicon for a semiconductor layer of a thin-film transistor), providing gate drivers in a monolithic manner have become more common. Conventionally, a gate driver is often mounted as an IC (Integrated Circuit) chip in a circumferential area around a substrate that constitutes a liquid crystal panel. However, in recent years, providing a gate driver directly on a substrate has gradually become popular. Such a gate driver is called for example as a “monolithic gate driver”, and a panel having a monolithic gate driver is called for example as a “gate driver monolithic panel”.

However, for a gate driver monolithic panel, it is not possible to employ the above described techniques in order to reduce accumulation of residual charges due to power-off. This will be explained in the following.

As for the technique disclosed in Japanese Unexamined Patent Application Publication No. 2004-45785, a gate driver 800 as an IC chip (hereinafter referred to as a “gate driver IC”) is typically configured as illustrated in FIG. 21. The gate driver IC 800 is configured by a low-voltage circuit unit 810 constituting a logic unit, and a high-voltage circuit unit 820 including a level shifting circuit 822 that converts a potential level of a signal outputted from the logic unit. The low-voltage circuit unit 810 includes a shift register 812 and an OR circuit 816. To an input terminal of the OR circuit 816, an output signal from each stage 814 of the shift register 812 and a signal ALL-ON for controlling whether or not all gate bus lines are to be in a selected state are inputted. An output signal from the OR circuit 816 is subjected to a potential conversion by the level shifting circuit 822. Then, the signal after the potential conversion by the level shifting circuit 822 is supplied to a gate bus line as a scanning signal. In the above configuration, by setting the logical level of the signal ALL-ON to the high level when the power is turned off, all the gate bus lines are turned to the selected state, and residual charges within all the pixel formation portions are discharged.

However, in the case of a monolithic gate driver, when a direct current bias is supplied to a gate terminal of a thin-film transistor, a threshold voltage of this thin-film transistor shifts. Therefore, the monolithic gate driver is configured by a Set-Reset flip-flop circuit so as not to supply a direct current bias to the gate terminal of the thin-film transistor. Specifically, a configuration of a single circuit stage in a shift register within the monolithic gate driver is as illustrated in FIG. 22, for example. In such a configuration, when an output signal OUTn−1 (a set signal S that will be later described) from a previous stage changes from low level to high level, a potential of a netA (an area within which a gate terminal of a thin-film transistor TI, a source terminal of a thin-film transistor TB, and a drain terminal of a thin-film transistor TL are connected to each other) increases. Thereafter, when a clock signal CK changes from low level to high level, the potential of the netA further increases due to the bootstrap effect of a capacitor CAP. With this, a high voltage is applied to the gate terminal of the thin-film transistor TI. As a result, based on the high level potential of the clock signal CK, a potential of the output signal OUTn (state signal Q that will be later described) increases up to a potential at which the gate bus lines are turned to the selected state. Here, the circuit illustrated in FIG. 22 is a bootstrap circuit using the clock signal CK and the capacitor CAP, and it is assumed that the potential of the output signal OUTn is maintained low level for most of the time. Accordingly, the circuit illustrated in FIG. 22 is not provided with a power source for generating a gate-ON potential (a potential of a signal to be supplied to a gate terminal of a switching element in a pixel formation portion when this switching element is turned to an ON state). Specifically, the monolithic gate driver does not include means (component) that turns all of the gate bus lines to the selected state. Thus, as for a gate driver monolithic panel, it is not possible to employ the technique disclosed in Japanese Unexamined Patent Application Publication No. 2004-45785. When a shift register operates based on a two-phase clock signal and the potential of the output signal OUTn is decreased down to the gate-OFF potential (pulled to the side of the gate-OFF potential) as needed, a configuration of a single stage in the shift register is as illustrated in FIG. 8, for example.

Further, as for the technique disclosed in Published International Application No. WO 2007/007768, since a threshold voltage of a thin-film transistor in a-Si TFT liquid crystal panel is high, residual charges with the pixel formation portion cannot be sufficiently discharged even if the gate-OFF potential reaches the ground potential.

Moreover, as for the technique disclosed in Japanese Unexamined Patent Application Publication No. 2007-11346, in a gate driver IC, it is not possible to increase the gate-OFF potential above the ground potential due to the following reasons. FIG. 23 is a view illustrating potential relation in an internal circuit of a gate driver IC. The values of the potential specifically shown in FIG. 23 are mere examples. As can be seen from FIG. 23, a low-voltage (logical) circuit unit operates between a ground potential GND and a power-supply potential VCC, and a high-voltage circuit unit operates between a gate-OFF potential VGL and a gate-ON potential VGH. Since the gate-OFF potential VGL is lower than the power-supply potential VCC and the ground potential GND in general, only a reverse voltage occurs in a PN parasitic element. Therefore, no current typically flows through the PN parasitic element. However, if the gate-OFF potential VGL is set to be a potential (e.g., 5 V) higher than the power-supply potential VCC, a forward voltage occurs in the PN parasitic element, and whereby a current flows therethrough. As a result, an abnormal operation of the gate driver IC occurs.

In the meantime, in a gate driver IC, an output unit for a scanning signal is configured as a CMOS. Specifically, the gate driver IC is configured to output one of the gate-ON potential VGH and the gate-OFF potential VGL from its output unit according to a voltage supplied to a gate of the CMOS. Therefore, a liquid crystal display device employing the gate driver IC can maintain the scanning signal at a low level. By contrast, in a monolithic gate driver, a single stage in a shift register has a circuit configuration as illustrated in FIG. 8 and FIG. 22. Here, a thin-film transistor TN is turned to the ON state only during a predetermined period (a period during which a single gate bus line is in the selected state) in a single vertical scanning period. Further, since the clock signal alternately repeats to be in high level and low level, thin-film transistors TM and TD are not maintained in the ON state in a continuous manner. Specifically, the potentials of the gate bus lines are not fixed at a low level. As described above, in the monolithic gate driver, although it is possible to set the gate-OFF potential VGL to be higher than the ground potential GND, residual charges within pixel formation portions are not discharged merely by this.

Thus, an object of the present invention is to provide a liquid crystal display device having a monolithic gate driver capable of quickly eliminating residual charges within pixel formation portions when the power-supply is turned off, in order to suppress lowering of visual quality when the power-supply is turned on.

### Means for Solving the Problems

A first aspect of the present invention is directed to a liquid crystal display device comprising:
a plurality of video signal lines respectively for transmitting a plurality of video signals representing an image to be displayed;
a plurality of scanning signal lines intersecting with the plurality of video signal lines;
a plurality of pixel formation portions arranged in matrix respectively corresponding to intersections between the plurality of video signal lines and the plurality of scanning signal lines, each pixel formation portion including a first switching element and a pixel electrode, the first switching element having a control terminal connected to the scanning signal line passing through the corresponding intersection and a first conductive terminal connected to the video signal line passing through the corresponding intersection, the pixel electrode being connected to a second conductive terminal of the first switching element;
a scanning signal line drive circuit including a shift register configured by a plurality of bistable circuits which are provided so as to have a one-to-one corresponding with the plurality of scanning signal lines, the shift register sequentially outputting a pulse based on a clock signal that cyclically repeats a first potential and a second potential, the scanning signal line drive circuit being configured to selectively drive the plurality of scanning signal lines based on the pulse outputted from the shift register and being formed on the same substrate as the substrate on which the plurality of scanning signal lines are formed;
a power-supply condition detecting unit configured to detect ON/OFF state of power-supply that is given externally;
a reference potential generating unit configured to generate a reference potential of the plurality of bistable circuits; and
a reference potential line for transmitting the reference potential generated by the reference potential generating unit to the plurality of bistable circuits, wherein
each bistable circuit includes a potential level maintaining unit for electrically connecting the corresponding scanning signal line with the reference potential line such that a potential level of the corresponding scanning signal line is maintained at the level of the reference potential during a time period in which the corresponding scanning signal line is in an unselected state, and
when the OFF state of the power-supply is detected by the power-supply condition detecting unit,
   the potential level maintaining unit included in each bistable circuit electrically connects the scanning signal line corresponding to the bistable circuit with the reference potential line, and
   the reference potential generating unit increasing the level of the reference potential up to a level at which the first switching element becomes conductive.

According to a second aspect of the present invention, in the first aspect of the present invention,
the liquid crystal display device further comprises a clock signal generating unit configured to generate the clock signal, wherein
the potential level maintaining unit included in each bistable circuit includes a second switching element having a first conductive terminal connected to the reference potential line, a second conductive terminal connected to the scanning signal line corresponding to the bistable circuit, and a control terminal to which the clock signal is supplied, and
when the OFF state of the power-supply is detected by the power-supply condition detecting unit, the clock signal generating unit sets the clock signal to the first potential or the second potential such that the second switching element included in each bistable circuit becomes conductive.

According to a third aspect of the present invention, in the second aspect of the present invention,
the potential level maintaining unit included in each bistable circuit includes a plurality of the second switching elements,
the clock signal generating unit generates a plurality of the clock signals to be respectively supplied to control terminals of the plurality of second switching elements included in each potential level maintaining unit, and
when the OFF state of the power-supply is detected by the power-supply condition detecting unit, the clock signal generating unit sets the plurality of clock signals to the first potential or the second potential respectively such that the plurality of second switching elements included in each potential level maintaining unit become conductive.

According to a fourth aspect of the present invention, in the first aspect of the present invention,
the reference potential generating unit includes a level shifting circuit configured to convert a potential level of a predetermined inputted signal, thereby supplying a predetermined high level potential or a predetermined low level potential to the reference potential line, and
the level shifting circuit supplies:
   the low level potential to the reference potential line as the reference potential, when the OFF state of the power-supply is not detected by the power-supply condition detecting unit, and
   the high level potential to the reference potential line as the reference potential, when the OFF state of the power-supply is detected by the power-supply condition detecting unit.

A fifth aspect of the present invention is directed to a method of driving a liquid crystal display device,
the liquid crystal display device provided with: a plurality of video signal lines respectively for transmitting a plurality of video signals representing an image to be displayed; a plurality of scanning signal lines intersecting with the plurality of video signal lines; a plurality of pixel formation portions arranged in matrix respectively corresponding to intersections between the plurality of video signal lines and the plurality of scanning signal lines, each pixel formation portion including a first switching element and a pixel electrode, the first switching element having a control terminal connected to the scanning signal line passing through the corresponding intersection and a first conductive terminal connected to the video signal line passing through the corresponding intersection, the pixel electrode being connected to a second conductive terminal of the first switching element; and a scanning signal line drive circuit formed on the same substrate as the substrate on which the plurality of scanning signal lines are formed and including a shift register configured by a plurality of bistable circuits which are provided so as to have a one-to-one corresponding with the plurality of scanning signal lines, the shift register sequentially outputting a pulse based on a clock signal that cyclically repeats a first potential and a second potential, the scanning signal line drive circuit being configured to selectively drive the plurality of scanning signal lines based on the pulse outputted from the shift register, the method comprising:
a power-supply condition detecting step of detecting ON/OFF state of power-supply that is given externally; and
a reference potential generating step of generating a reference potential of the plurality of bistable circuits, wherein
the liquid crystal display device is further provided with a reference potential line for transmitting the reference potential generated in the reference potential generating step to the plurality of bistable circuits, and
when the OFF state of the power-supply is detected in the power-supply condition detecting step,
   the scanning signal line corresponding to each bistable circuit and the reference potential line are electrically connected, and
   the level of the reference potential is increased up to a level at which the first switching element becomes conductive in the reference potential generating step.

According to a sixth aspect of the present invention, in the fifth aspect of the present invention,
the method further comprises a clock signal generating step of generating the clock signal, wherein
each bistable circuit includes a second switching element having a first conductive terminal connected to the reference potential line, a second conductive terminal connected to the scanning signal line corresponding to the bistable circuit, and a control terminal to which the clock signal is supplied, and
when the OFF state of the power-supply is detected in the power-supply condition detecting step, the clock signal is set to the first potential or the second potential such that the second switching element included in each bistable circuit becomes conductive in the clock signal generating step.

According to a seventh aspect of the present invention, in the sixth aspect of the present invention,
each bistable circuit includes a plurality of the second switching elements,
a plurality of the clock signals to be respectively supplied to control terminals of the plurality of second switching elements included in each bistable circuit are generated in the clock signal generating step, and
when the OFF state of the power-supply is detected in the power-supply condition detecting step, the plurality of clock signals are set to the first potential or the second potential such that the plurality of second switching elements included in each bistable circuit become conductive in the clock signal generating step.

According to an eighth aspect of the present invention, in the fifth aspect of the present invention,
the method further comprises a level converting step of converting a potential level of a predetermined inputted signal to supply a predetermined high level potential or a predetermined low level potential to the reference potential line, and
in the level converting step,
   when the OFF state of the power-supply is not detected in the power-supply condition detecting step, the potential level of the inputted signal is converted to the low level potential, and
   when the OFF state of the power-supply is detected in the power-supply condition detecting step, the potential level of the inputted signal is converted to the high level potential.

### Effects of the Invention

According to the first aspect of the present invention, each of the bistable circuits configuring the shift register within the scanning signal line drive circuit is provided with a potential level maintaining unit configured to maintain the potential level of a scanning signal line that corresponds to the bistable circuit at the reference potential through the time period in which the scanning signal line is to be in the unselected state. Then, upon detection of the OFF state of the power-supply, the potential level maintaining unit electrically connects the scanning signal line with the reference potential line (for transmitting the reference potential). Further, when the OFF state of the power-supply is detected, a level of the reference potential is increased up to the level at which the switching element provided for each pixel formation portion becomes conductive. With this, each scanning signal line is turned to the selected state, and the switching element provided for each pixel formation portion becomes conductive. Therefore, when the power-supply is turned off, residual charges within the pixel formation portions are quickly discharged. As a result, it is possible to suppress lowering of the visual quality due to residual charges within the pixel formation portions when the power-supply is next turned on.

According to the second aspect of the present invention, the potential level maintaining unit is used as a component for turning each scanning signal line to the selected state when the OFF state of the power-supply is detected, and this potential level maintaining unit is realized by the switching element that has been conventionally provided in order to maintain the potential of the scanning signal line at the level of the reference potential. Therefore, it is possible to realize the liquid crystal display device providing the same effect as that according to the first aspect of the present invention relatively easily.

According to the third aspect of the present invention, in the liquid crystal display device provided with the scanning signal line drive circuit having the shift register that operates based on the plurality of clock signals, residual charges within the pixel formation portions are quickly discharged when the power-supply is turned off, and lowering of the visual quality when the power-supply is next turned on is suppressed.

According to the fourth aspect of the present invention, the potential of the output signal from the level shifting circuit is supplied as the reference potential through the reference potential line to each of the bistable circuits configuring the shift register. Therefore, it is possible to easily make the level of the reference potential supplied to the bistable circuit variable, and to turn the scanning signal line to the selected state by increasing the level of the reference potential when the scanning signal line is electrically connected with the reference potential line by the potential level maintaining unit. In the meantime, in a liquid crystal display device employing a monolithic gate driver (the scanning signal line drive circuit formed on the same substrate as the substrate on which the scanning signal lines are formed), a level shifting circuit is conventionally provided outside a panel. Therefore, it is not necessary to increase the number of circuit components and such even if an output signal from the level shifting circuit is used for the reference potential, and to realize the liquid crystal display device capable of quickly eliminating residual charges within the pixel formation portions when the power-supply is turned off at low cost.

### BRIEF DESCRIPTION OF THE DRAWINGS

FIG. 1 is a signal waveform diagram for illustrating an operation when power-supply is cut off in an active matrix-type liquid crystal display device according to a first embodiment of the present invention.

FIG. 2 is a block diagram illustrating an overall configuration of the liquid crystal display device according to the first embodiment.

FIG. 3 is a circuit diagram illustrating a configuration of a pixel formation portion according to the first embodiment.

FIG. 4 is a diagram illustrating a configuration of a reference potential switching circuit according to the first embodiment.

FIG. 5 is a block diagram for illustrating a configuration of a gate driver according to the first embodiment.

FIG. 6 is a block diagram illustrating a configuration of a shift register within the gate driver according to the first embodiment.

FIG. 7 is a signal waveform diagram for illustrating an operation of the gate driver according to the first embodiment.

FIG. 8 is a circuit diagram illustrating a configuration of a bistable circuit included in the shift register according to the first embodiment.

FIG. 9 is a signal waveform diagram for illustrating an operation of the bistable circuit according to the first embodiment.

FIG. 10 is a block diagram illustrating an overall configuration of the liquid crystal display device according to a second embodiment of the present invention.

FIG. 11 is a diagram for illustrating effects according to the second embodiment.

FIG. 12 is a diagram for illustrating effects according to the second embodiment.

FIG. 13 is a diagram for illustrating modified examples of the second embodiment.

FIG. 14 is a block diagram illustrating an example of a configuration of a shift register operating based on four-phase clock signals.

FIG. 15 is a circuit diagram illustrating a configuration of a bistable circuit included in the shift register operating based on four-phase clock signals.

FIG. 16 is a signal waveform diagram of the four-phase clock signals.

FIG. 17 is a signal waveform diagram for illustrating an operation of the bistable circuit included in the shift register operating based on the four-phase clock signals.

FIG. 18 is a block diagram for illustrating a liquid crystal display device having gate drivers on both sides of a display unit.

FIG. 19 is a block diagram for illustrating a liquid crystal display device in which a source driver is configured by a single IC chip.

FIG. 20 is a block diagram for illustrating a liquid crystal display device having a single-chip driver.

FIG. 21 is a block diagram illustrating a general configuration of a gate driver IC.

FIG. 22 is a circuit diagram illustrating a configuration of a single stage in a shift register within a monolithic gate driver.

FIG. 23 is a view for illustrating a potential relation in an internal circuit of a gate driver IC.

### MODE FOR CARRYING OUT THE INVENTION

Embodiments according to the present invention will be now described below with reference to the accompanying drawings.

### 1. First Embodiment

<1.1 Overall Configuration and Operation>

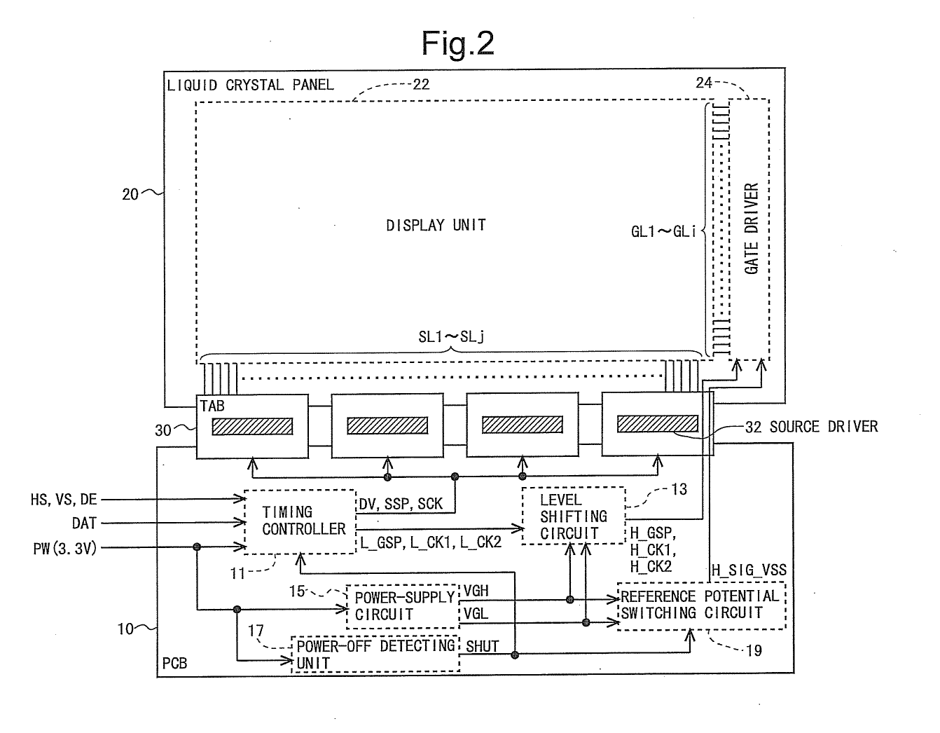

FIG. 2 is a block diagram illustrating an overall configuration of an active matrix-type liquid crystal display device according to a first embodiment of the present invention. Referring to FIG. 2, this liquid crystal display device is configured by a liquid crystal panel 20, a PCB (printed circuit board) 10, and a TAB (Tape Automated Bonding) 30 connected to the liquid crystal panel 20 and to the PCB 10.

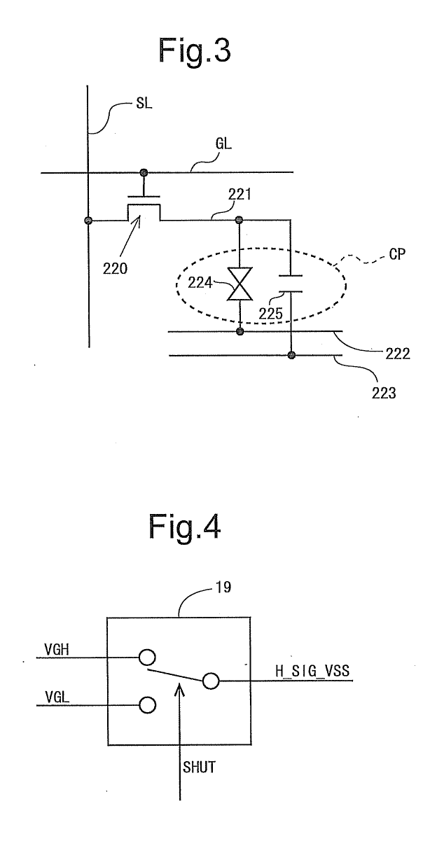

The liquid crystal panel 20 is provided with a display unit 22 for displaying an image. The display unit 22 includes a plurality (number j) of source bus lines (video signal lines) SL1 to SLj, a plurality (number i) of gate bus lines (scanning signal lines) GL1 to GLi, and a plurality (i×j) of pixel formation portions provided respectively corresponding to intersections between the source bus lines SL1 to SLj and the gate bus lines GL1 to GLi. FIG. 3 is a circuit diagram illustrating a configuration of the pixel formation portion. Referring to FIG. 3, each pixel formation portion includes a thin-film transistor (TFT) 220 having a gate terminal (control terminal) connected to the gate bus line GL that passes through a corresponding intersection and a source terminal (first conductive terminal) connected to the source bus line SL that passes through the corresponding intersection, a pixel electrode 221 connected to a drain terminal (second conductive terminal) of the thin-film transistor 220, a common electrode 222 and an auxiliary capacitance electrode 223 that are provided so as to be shared by the plurality of pixel formation portions, a liquid crystal capacitance 224 formed by the pixel electrode 221 and the common electrode 222, and an auxiliary capacitance 225 formed by the pixel electrode 221 and the auxiliary capacitance electrode 223. Further, a pixel capacitance CP is formed by the liquid crystal capacitance 224 and the auxiliary capacitance 225. Then, a voltage indicating a pixel value is stored in the pixel capacitance CP, based on a video signal that the source terminal of the thin-film transistor 220 receives from the source bus line SL when the gate terminal of each thin-film transistor 220 receives an active scanning signal from the gate bus line GL.

As illustrated in FIG. 2, in the liquid crystal panel 20, a gate driver 24 for driving the gate bus lines GL1 to GLi is also formed. Specifically, the gate driver 24 is formed monolithically over a glass substrate that constitutes the liquid crystal panel 20. The TAB 30 is provided with a source driver 32, in a form of an IC chip, for driving the source bus lines SL1 to SLj. In the PCB 10, a timing controller 11, a level shifting circuit 13, a power-supply circuit 15, a power-OFF detecting unit 17, and a reference potential switching circuit 19 are formed. In the following description, a potential taken as a reference when a shift register included in the gate driver 24 operates is referred to as a “reference potential” (note that this potential is variable in this embodiment)

The liquid crystal display device is externally supplied with timing signals such as a horizontal synchronizing signal HS, a vertical synchronizing signal VS, and a data enable signal DE, as well as an image signal DAT and a power-supply voltage PW. The power-supply voltage PW is supplied to the timing controller 11, the power-supply circuit 15, and the power-OFF detecting unit 17. In this embodiment, the power-supply voltage PW is 3.3 V.

The power-supply circuit 15 generates a gate-ON potential VGH for turning the gate bus line to a selected state and a gate-OFF potential VGL for turning the gate bus line to an unselected state, based on the power-supply voltage PW. The gate-ON potential VGH and the gate-OFF potential VGL are supplied to the level shifting circuit 13 and the reference potential switching circuit 19. The power-OFF detecting unit 17 outputs a power-supply condition signal SHUT indicating a supply condition of the power-supply voltage PW (ON/OFF condition of power-supply). The power-supply condition signal SHUT is supplied to the timing controller 11 and the reference potential switching circuit 19. The reference potential switching circuit 19 is configured such that a selector switch as illustrated in FIG. 4 is realized using such as a transistor. Specifically, the reference potential switching circuit 19 outputs one of the gate-ON potential VGH and the gate-OFF potential VGL as a reference potential H_SIG_VSS, according to a magnitude of the voltage of the power-supply condition signal SHUT. To be more specific, the gate-OFF potential VGL is outputted as the reference potential H_SIG_VSS when the power-supply condition signal SHUT is at a low level, and the gate-ON potential VGH is outputted as the reference potential H_SIG_VSS if the power-supply condition signal SHUT is at a high level. The reference potential H_SIG_VSS is transmitted through a reference potential line and supplied to the gate driver 24.

The timing controller 11 receives the timing signals such as the horizontal synchronizing signal HS, the vertical synchronizing signal VS, and the data enable signal DE, as well as the image signal DAT, the power-supply voltage PW, and the power-supply condition signal SHUT, and generates a digital video signal DV, a source start pulse signal SSP, a source clock signal SCK, a gate start pulse signal L_GSP, a first gate clock signal L_CK1, and a second gate clock signal L_CK2. The digital video signal DV, the source start pulse signal SSP, and the source clock signal SCK are supplied to the source driver 32, and the gate start pulse signal L_GSP, the first gate clock signal L_CK1, and the second gate clock signal L_CK2 are supplied to the level shifting circuit 13. Here, regarding the gate start pulse signal L_GSP, the first gate clock signal L_CK1, and the second gate clock signal L_CK2, a high level side potential is the power-supply voltage (3.3 V) PW, and a low level side potential is the ground potential (0 V) GND.

The level shifting circuit 13 converts potential levels of the gate start pulse signal L_GSP, the first gate clock signal L_CK1, and the second gate clock signal L_CK2 which are outputted from the timing controller 11, using the gate-ON potential VGH and the gate-OFF potential VGL which are supplied from the power-supply circuit 15. A gate start pulse signal H_GSP, a first gate clock signal H_CK1, and a second gate clock signal H_CK2 after the potential level conversion by the level shifting circuit 13 are supplied to the gate driver 24. In the potential level conversion by the level shifting circuit 13, a potential of the first gate clock signal H_CK1 is set to the gate-OFF potential VGL when the first gate clock signal L_CK1 is at a low level, and the potential of the first gate clock signal H_CK1 is set to the gate-ON potential VGH when the first gate clock signal L_CK1 is at a high level. The second gate clock signal L_CK2 and the gate start pulse signal L_GSP are converted in the same manner.

The source driver 32 receives the digital video signal DV, the source start pulse signal SSP, and the source clock signal SCK which are outputted from the timing controller 11, and applies a driving video signal to each of the source bus lines SL1 to SLj.

The gate driver 24 repeats application of an active scanning signal to each of the gate bus lines GL1 to GLi taking a single vertical scanning period as a single cycle, based on the gate start pulse signal H_GSP, the first gate clock signal H_CK1, and the second gate clock signal H_CK2 which are outputted from the level shifting circuit 13 as well as on the reference potential H_SIG_VSS outputted from the reference potential switching circuit 19. The gate driver 24 will be described in more detail later.

By applying the driving video signal to each of the source bus lines SL1 to SLj and applying the scanning signal to each of the gate bus lines GL1 to GLi in the above manner, an image based on the image signal DAT supplied externally is displayed in the display unit 22.

In this embodiment, a power-supply condition detecting unit is realized by the power-OFF detecting unit 17, a reference potential generating unit is realized by the reference potential switching circuit 19, and a clock signal generating unit is realized by the timing controller 11 and the level shifting circuit 13.

<1.2 Configuration and Operation of Gate Driver>

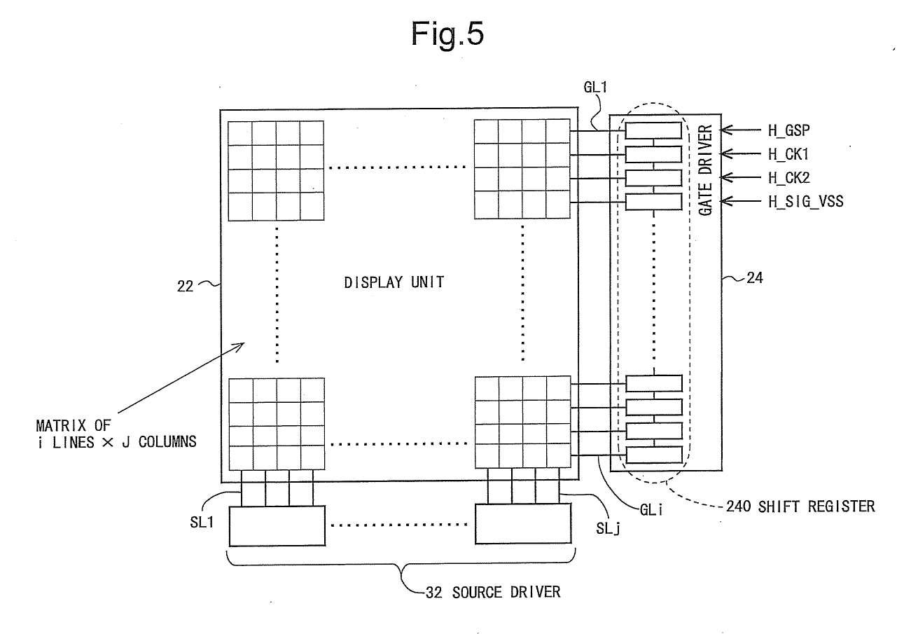

Next, a configuration and an operation of the gate driver 24 according to this embodiment will be described. Referring to FIG. 5, the gate driver 24 is configured by a shift register 240 including a plurality of stages. The display unit 22 is provided with a pixel matrix of i lines×j columns, and each stage of a shift register 240 is provided so as to correspond to each line of the pixel matrix. Further, each stage of the shift register 240 is a bistable circuit that is in either one of two states at each time point, and that outputs a signal indicating this state (hereinafter referred to as a “state signal”). Here, a state signal outputted from each stage of the shift register 240 is supplied as a scanning signal to a corresponding gate bus line.

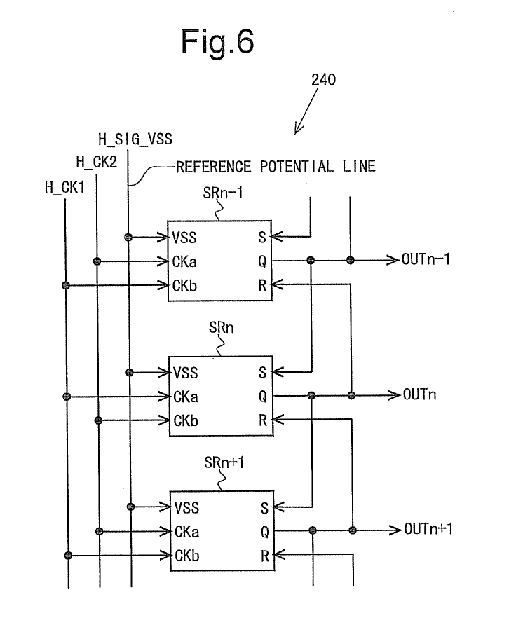

FIG. 6 is a block diagram illustrating a configuration of the shift register 240 within the gate driver 24. Here, FIG. 6 shows a configuration of bistable circuits SRn−1, SRn, and SRn+1 respectively of a (n−1)-th stage, an n-th stage, and a (n+1)-th stage of the shift register 240. Each bistable circuit is provided with input terminals for receiving a reference potential VSS, a first clock CKa, a second clock CKb, a set signal S, and a reset signal R respectively, and an output terminal for outputting a state signal Q. In this embodiment, the reference potential H_SIG_VSS outputted from the reference potential switching circuit 19 is supplied as the reference potential VSS, one of the first gate clock signal H_CK1 and the second gate clock signal H_CK2 outputted from the level shifting circuit 13 is supplied as the first clock CKa, and the other of the first gate clock signal H_CK1 and the second gate clock signal H_CK2 is supplied as the second clock CKb. Further, the state signal Q outputted from a previous stage is supplied as the set signal S, and the state signal Q outputted from a subsequent stage is supplied as the reset signal R. Specifically, when focusing attention on the n-th stage, a scanning signal OUTn−1 supplied to a (n−1)-th gate bus line is supplied as the set signal S, and a scanning signal OUTn+1 supplied to a (n+1)-th gate bus line is supplied as the reset signal R.

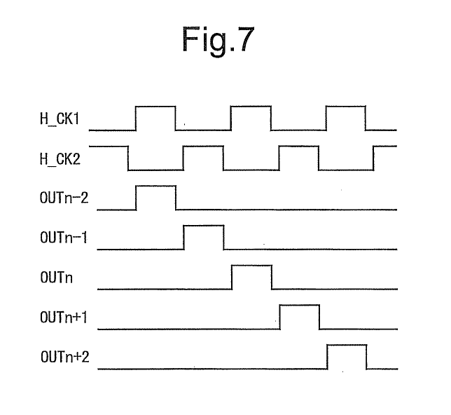

In the above configuration, when a pulse of the gate start pulse signal H_GSP as the set signal S is supplied to a first stage of the shift register 240, based on the first gate clock signal H_CK1 and the second gate clock signal H_CK2 each having an on-duty set to be around 50 percents (see FIG. 7), a pulse included in the gate start pulse signal H_GSP (this pulse is included in the state signal Q outputted from each stage) is sequentially transferred from the first stage to the i-th stage. According to the transfer of the pulse, the state signals Q outputted from the respective stages are sequentially set to high level. Then, the state signals Q outputted from the stages are respectively supplied as scanning signals OUT1 to OUTi to the gate bus lines GL1 to Gli. With this, as illustrated in FIG. 7, the scanning signals OUT1 to OUTi that have been sequentially set to high level by a predetermined period are supplied to the gate bus lines GL1 to GLi within the display unit 22.

<1.3 Configuration and Operation of Bistable Circuit>

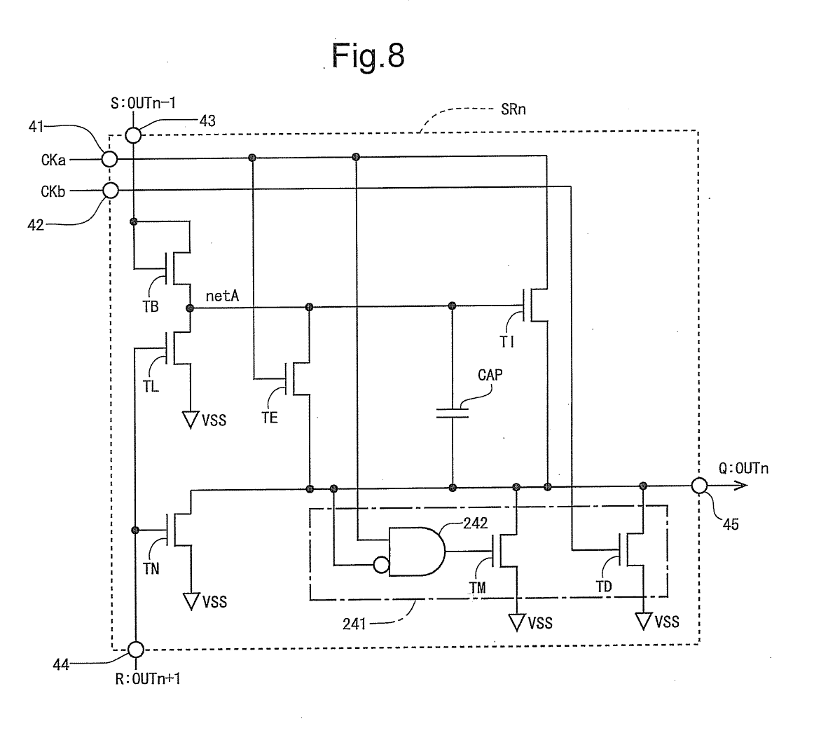

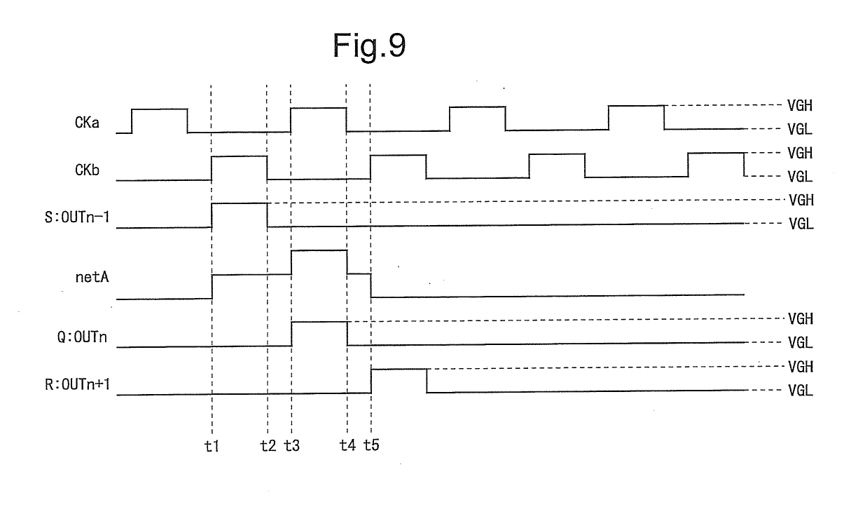

FIG. 8 is a circuit diagram illustrating a configuration of a bistable circuit included in the shift register 240 (a configuration of the n-th stage of the shift register 240). Referring to FIG. 8, a bistable circuit SRn is provided with seven thin-film transistors TI, TB, TL, TN, TE, TM, and TD, a capacitor CAP, and an AND circuit 242. In FIG. 8, an input terminal for receiving the first clock CKa is represented by a reference numeral 41, an input terminal for receiving the second clock CKb is represented by a reference numeral 42, an input terminal for receiving the set signal S is represented by a reference numeral 43, an input terminal for receiving the reset signal R is represented by a reference numeral 44, and an output terminal for outputting the state signal Q is represented by a reference numeral 45.

A source terminal of the thin-film transistor TB, a drain terminal of the thin-film transistor TL, agate terminal of the thin-film transistor TI, a source terminal of the thin-film transistor TE, and one terminal of the capacitor CAP are connected to each other. Note that, an area (wiring) within which these terminals are connected to each other is referred to as a “netA” for convenience sake.

The thin-film transistor TI is configured such that its gate terminal, drain terminal, and source terminal are respectively connected to the netA, the input terminal 41, and the output terminal 45. The thin-film transistor TB is configured such that its gate terminal and drain terminal are connected to the input terminal 43 (specifically, diode-connected), and its source terminal is connected to the netA. The thin-film transistor TL is configured such that its gate terminal, drain terminal, and source terminal are respectively connected to the input terminal 44, the netA, and the reference potential line. The thin-film transistor TN is configured such that its gate terminal, drain terminal, and source terminal are respectively connected to the input terminal 44, the output terminal 45, and the reference potential line. The thin-film transistor TE is configured such that its gate terminal, drain terminal, and source terminal are respectively connected to the input terminal 41, the output terminal 45, and the netA. The thin-film transistor TM is configured such that its gate terminal, drain terminal, and source terminal are respectively connected to an output terminal of the AND circuit 242, the output terminal 45, and the reference potential line. The thin-film transistor TD is configured such that its gate terminal, drain terminal, and source terminal are respectively connected to the input terminal 42, the output terminal 45, and the reference potential line. The capacitor CAP is configured such that one terminal thereof is connected to the netA and the other terminal is connected to the output terminal 45. The AND circuit 242 is configured such that a signal indicating a logical AND between a logical value of a logical inversion signal of the state signal Q and a logical value of the first clock CKa is supplied to the gate terminal of the thin-film transistor TM.

Next, a function of each component in the bistable circuit will be described. The thin-film transistor TI supplies a potential of the first clock Cka to the output terminal 45 when a potential of the netA is at a high level. The thin-film transistor TB sets the potential of the netA to high level when the set signal S is at a high level. The thin-film transistor TL sets the potential of the netA to low level when the reset signal R is at a high level. The thin-film transistor TN sets a potential of the state signal Q (the output terminal 45) to low level when the reset signal R is at a high level. The thin-film transistor TE makes the potential of the netA and the potential of the state signal Q equal when the thin-film transistor TE is in the ON state. The capacitor CAP serves as a capacitance for achieving a bootstrap effect of increasing the potential of the netA as the potential of the state signal Q increases.

The AND circuit 242 supplies the signal indicating the logical AND between the logical value of the logical inversion signal of the state signal Q and the logical value of the first clock CKa to the gate terminal of the thin-film transistor TM. Specifically, when the state signal Q is at a low level, the first clock CKa is supplied to the gate terminal of the thin-film transistor TM. The thin-film transistor TM sets the potential of the state signal Q to low level, when output signal from the AND circuit 242 is at a high level. The thin-film transistor TD sets the potential of the state signal Q to low level, when the second clock CKb is at a high level. The AND circuit 242, the thin-film transistor TM, and the thin-film transistor TD are provided in order to decrease the potential level of the state signal Q down to a level of the reference potential as needed during a time period in which the gate bus line connected to this bistable circuit SRn is to be in the unselected state (the level of the reference potential is at the level of the gate-OFF potential during a time period in which the power-supply voltage PW is normally supplied). In other words, the AND circuit 242, the thin-film transistor TM, and the thin-film transistor TD are provided such that the potential of the state signal Q is maintained at the level of the reference potential when focusing on a relatively longer time period, although the potential level of the state signal Q is slightly higher than the level of the reference potential as for an extremely short period of time. As described above, in this embodiment, a potential level maintaining unit 241 is realized by the AND circuit 242, the thin-film transistor TM, and the thin-film transistor TD.

Next, an operation of the bistable circuit SRn when the power-supply voltage PW is externally supplied in a normal manner will be described with reference to FIG. 9. During a time period in which the liquid crystal display device operates, the bistable circuit SRn is supplied with the first clock CKa and the second clock CKb each having an on-duty set to be around 50 percents. Here, regarding the first clock CKa and the second clock CKb, a high level side potential is the gate-ON potential VGH, and a low level side potential is the gate-OFF potential VGL. Further, in the following description, it is assumed that the reference potential VSS and the gate-OFF potential VGL are equal. However, the reference potential VSS and the gate-OFF potential VGL can be different (e.g., the reference potential VSS is −7 V and the gate-OFF potential is −10 V).

At a time point t1, when the set signal S changes from low level to high level, the thin-film transistor TB is turned to the ON state as being diode-connected as illustrated in FIG. 8. With this, the capacitor CAP is charged, and the potential of the netA changes from low level to high level. This turns the thin-film transistor TI to the ON state. Here, during a time period from t1 to t3, the first clock CKa is at a low level. Therefore, during this time period, the state signal Q is maintained at a low level. Further, during this time period, since the reset signal R is at a low level, the thin-film transistor TL is maintained to be an OFF state. Therefore, the potential of the netA does not decrease during this time period.

After the set signal S changes from high level to low level at a time point t2, when reaching a time point t3, the first clock CKa changes from low level to high level. At this time, since the thin-film transistor TI is in the ON state, the potential of the output terminal 45 increases as the potential of the input terminal 41 increases. Here, since the capacitor CAP is provided between the netA and the output terminal 45 as illustrated in FIG. 8, the potential of the netA increases as the potential of the output terminal 45 increases (the netA is bootstrapped). Ideally, the potential of the netA increases up to a potential twice as high as the gate-ON potential VGH. As a result, a high voltage is applied to the gate terminal of the thin-film transistor TI, and the potential of the output terminal 45 increases up to a high level potential of the first clock Cka, i.e., the gate-ON potential VGH. With this, the gate bus line connected to the output terminal 45 of this bistable circuit SRn is turned to the selected state. Here, during a time period from t3 to t4, the thin-film transistor TN is maintained to be the OFF state as the reset signal R is at a low level, and the thin-film transistor TD is maintained to be the OFF state as the second clock CKb is at a low level. Further, during this time period, since the state signal Q is at a high level, the output signal from the AND circuit 242 is set to a low level and the thin-film transistor TM is in the OFF state. Accordingly, the potential of the state signal Q does not decrease during this time period. Moreover, during the time period from t3 to t4, although the first clock CKa is at a high level, the potential of the netA is approximately twice as high as the gate-ON potential VGH, and the potential of the state signal Q is equal to the gate-ON potential VGH, and therefore the thin-film transistor TE is in the OFF state. Further, during this time period, since the reset signal R is at a low level, the thin-film transistor TL is maintained to be an OFF state. Accordingly, the potential of the netA does not decrease during this time period.

At a time point t4, the first clock CKa changes from high level to low level. With this, the potential of the output terminal 45, i.e., the potential of the state signal Q decreases as the potential of the input terminal 41 decreases. Therefore, the potential of the netA also decreases through the capacitor CAP. At a time point t5, the reset signal R changes from low level to high level. With this, the thin-film transistor TL and the thin-film transistor TN are turned to the ON state. As a result, the potential of the netA and the potential of the state signal Q become low level.

By performing the above operation by each bistable circuit of the shift register 240, the scanning signals OUT1 to OUTi which are sequentially set to high level by a predetermined period are supplied to the gate bus lines GL1 to GLi of the display unit 22. In this embodiment, the first clock CKa and the second clock CKb are alternately set to high level for every other predetermined period as illustrated in FIG. 9. Therefore, the thin-film transistor TD and the thin-film transistor TM are alternately turned to the ON state every other predetermined, period. With this, each gate bus line is electrically connected to the reference potential line every other predetermined period (excluding a time period to be in the selected state), and the state signal Q is maintained at a low level through a time period to be in the unselected state.

<1.4 Operation When Power-Supply is Cut Off>

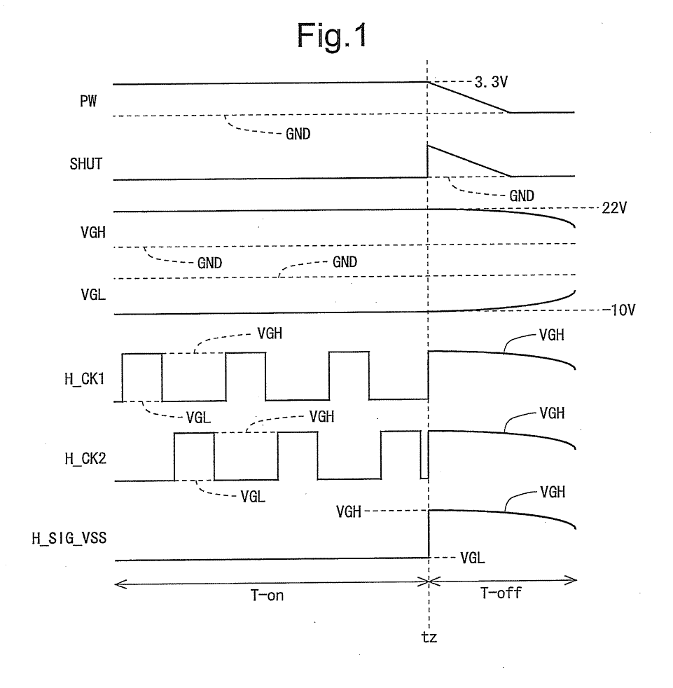

Next, an operation of the liquid crystal display device when external supply of the power-supply voltage PW is cut off will be described with reference to FIG. 1, FIG. 2, and FIG. 8. FIG. 1 shows waveforms of the power-supply voltage PW, the power-supply condition signal SHUT, the gate-ON potential VGH, the gate-OFF potential VGL, the first gate clock signal H_CK1, the second gate clock signal H_CK2, and the reference potential H_SIG_VSS. Here, in FIG. 1, a time period represented by a reference numeral T-on indicates a time period in which the power-supply voltage PW is normally supplied, a time point represented by a reference numeral tz indicates a time point at which the supply of the power-supply voltage PW is cut off, and a time period represented by a reference numeral T-off indicates a time period in which the power-supply voltage PW is not supplied.

During the time period in which the power-supply voltage PW is normally supplied, the gate-ON potential VGH and the gate-OFF potential VGL supplied from the power-supply circuit 15 to the level shifting circuit 13 and the reference potential switching circuit 19 are maintained, for example, at 22 V and −10 V, respectively. Further, during this time period, the power-OFF detecting unit 17 maintains the power-supply condition signal SHUT at a low level (here, the ground potential GND). Based on this power-supply condition signal SHUT, the reference potential switching circuit 19 maintains the reference potential H_SIG_VSS at the gate-OFF potential VGL. Moreover, the timing controller 11 sets the first gate clock signal L_CK1 and the second gate clock signal L_CK2 alternately to high level for every other predetermined period, based on the power-supply condition signal SHUT. As described above, regarding the first gate clock signal L_CK1 and the second gate clock signal L_CK2, the high level side potential is the power-supply voltage PW, and the low level side potential is the ground potential GND. The first gate clock signal L_CK1 and the second gate clock signal L_CK2 are subjected to the potential level conversion by the level shifting circuit 13 as described above. Thus, during the time period in which the power-supply voltage PW is normally supplied, as illustrated in FIG. 1, the first gate clock signal H_CK1 and the second gate clock signal H_CK2 repeats the gate-ON potential VGH and the gate-OFF potential VGL alternately, and the reference potential H_SIG_VSS is maintained at the gate-OFF potential VGL.

When the supply of the power-supply voltage PW is cut off at the time point tz, as illustrated in FIG. 1, the gate-ON potential VGH and the gate-OFF potential VGL become gradually closer to the ground potential GND. Further, upon detection of the cutoff of the supply of the power-supply voltage PW (the OFF state of the power-supply), the power-OFF detecting unit 17 sets the power-supply condition signal SHUT to high level. Upon detection of the power-supply condition signal SHUT being to be high level, the timing controller 11 sets the first gate clock signal L_CK1 and the second gate clock signal L_CK2 to high level. The first gate clock signal L_CK1 and the second gate clock signal L_CK2 are subjected to the potential level conversion by the level shifting circuit 13. At this time, since the first gate clock signal L_CK1 and the second gate clock signal L_CK2 are both at a high level, the first gate clock signal H_CK1 and the second gate clock signal H_CK2 are set to the gate-ON potential VGH. Moreover, the reference potential switching circuit 19 switches the reference potential H_SIG_VSS from the gate-OFF potential VGL to the gate-ON potential VGH based on the power-supply condition signal SHUT. Thus, at the time point tz at which the supply of the power-supply voltage PW is cut off, as illustrated in FIG. 1, the reference potential H_SIG_VSS, the first gate clock signal H_CK1, and the second gate clock signal H_CK2 are set to the gate-ON potential VGH.

When both of the first gate clock signal H_CK1 and the second gate clock signal H_CK2 are set to the gate-ON potential VGH, the first clock CKa and the second clock CKb supplied to each bistable circuit (see FIG. 8) are both set to high level. Then, by the second clock CKb turning to the high level, the thin-film transistor TD is turned to the ON state. Further, the gate bus lines are turned to the selected state only for a short period of time in a single vertical scanning period, and therefore the state signals Q of most of the bistable circuits are at the low level. Therefore, by the first clock CKa turning to the high level, the output signal from the AND circuit 242 is set to high level in the most of the bistable circuits, and the thin-film transistor TM is turned to the ON state. With this, the gate bus line connected to each bistable circuit is electrically connected to the reference potential line that transmits the reference potential H_SIG_VSS. Moreover, in this embodiment, at the time point tz at which the supply of the power-supply voltage PW is cut off, the reference potential H_SIG_VSS increases from the gate-OFF potential VGL to the gate-ON potential VGH. This increases the potential of the state signal Q outputted from each bistable circuit, and the thin-film transistor 220 is turned to the ON state in each pixel formation portion within the display unit 22 (see FIG. 3). As a result, the residual charges in the pixel formation portions are quickly discharged.

<1.5 Effects>

According to this embodiment, the bistable circuit that constitute the shift register 240 within the gate driver 24 is provided with the potential level maintaining unit 241 for maintaining the potential of the state signal Q at a low level (strictly speaking, decreasing the potential level of the state signal Q down to the level of the reference potential as needed) through the time period in which the gate bus line connected to this bistable circuit is to be in the unselected state. The potential level maintaining unit 241 is configured by the AND circuit 242 for supplying the signal indicating the logical AND between the logical value of the logical inversion signal of the state signal Q and the logical value of the first clock CKa to the gate terminal of the thin-film transistor TM, the thin-film transistor TM for electrically connecting the gate bus line and the reference potential line when the output signal from the AND circuit 242 is at a high level, and the thin-film transistor TD for electrically connecting the gate bus line and the reference potential line when the second clock CKb is at a high level. In such a configuration, when the external supply of the power-supply voltage PW is cut off, the first clock CKa and the second clock CKb are set to high level. With this, in each bistable circuit, the thin-film transistor TM and the thin-film transistor TD are set to the ON state, and the gate bus line and the reference potential line are electrically connected. Further, when the external supply of the power-supply voltage PW is cut off, the level of the reference potential VSS supplied to each bistable circuit is increased from the gate-OFF potential VGL to the gate-ON potential VGH. With this, since the gate bus lines are turned to the selected state and the thin-film transistor 220 of each pixel formation portion is turned to the ON state, the residual charges of the pixel formation portions are quickly discharged. As a result, when the power-supply of the liquid crystal display device is next turned on, lowering of the visual quality due to residual charges accumulated within the pixel formation portions is suppressed.

### 2. Second Embodiment

A second embodiment of the present invention will be now described. Here, only differences from the first embodiment will be described in detail, and the similarities with the first embodiment will be described only briefly.

<2.1 Overall Configuration and Operation>

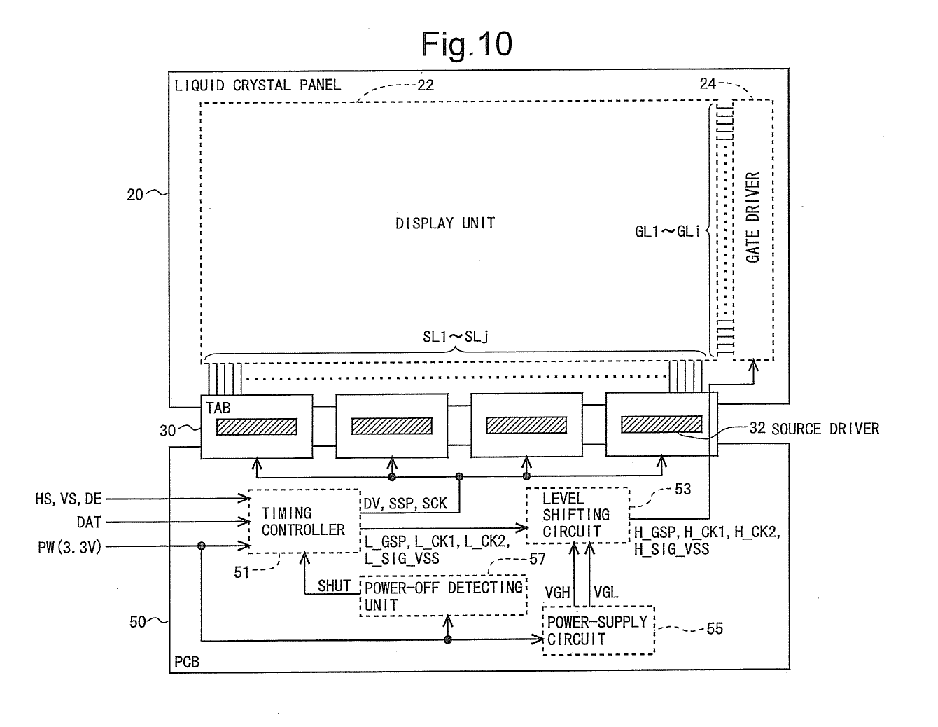

FIG. 10 is a block diagram illustrating an overall configuration of an active matrix-type liquid crystal display device according to the second embodiment of the present invention. The liquid crystal panel 20 and the TAB 30 are configured in the same manner as in the first embodiment. In the PCB 50, a timing controller 51, a level shifting circuit 53, a power-supply circuit 55, and a power-OFF detecting unit 57 are formed.

The power-supply circuit 55 generates the gate-ON potential VGH and the gate-OFF potential VGL based on the power-supply voltage PW. The gate-ON potential VGH and the gate-OFF potential VGL are supplied to the level shifting circuit 53. The power-OFF detecting unit 57 outputs the power-supply condition signal SHUT indicating a supply condition of the power-supply voltage PW (ON/OFF condition of power-supply). The power-supply condition signal SHUT is supplied to the timing controller 51.

The timing controller 51 receives the timing signals such as the horizontal synchronizing signal HS, the vertical synchronizing signal VS, and the data enable signal DE, as well as the image signal DAT, the power-supply voltage PW, and the power-supply condition signal SHUT, and generates the digital video signal DV, the source start pulse signal SSP, the source clock signal SCK, the gate start pulse signal L_GSP, the first gate clock signal L_CK1, the second gate clock signal L_CK2, and a reference potential L_SIG_VSS. The digital video signal DV, the source start pulse signal SSP, and the source clock signal SCK are supplied to the source driver 32, and the gate start pulse signal L_GSP, the first gate clock signal L_CK1, the second gate clock signal L_CK2, and the reference potential L_SIG_VSS are supplied to the level shifting circuit 53. Here, regarding the reference potential L_SIG_VSS, a high level side potential is the power-supply voltage PW, and a low level side potential is the ground potential GND.

The level shifting circuit 53 converts potential levels of the gate start pulse signal L_GSP, the first gate clock signal L_CK1, the second gate clock signal L_CK2, and the reference potential L_SIG_VSS which are outputted from the timing controller 51, using the gate-ON potential VGH and the gate-OFF potential VGL which are supplied from the power-supply circuit 55. The gate start pulse signal H_GSP, the first gate clock signal H_CK1, the second gate clock signal H_CK2, and the reference potential H_SIG_VSS after the potential level conversion by the level shifting circuit 53 are supplied to the gate driver 24. In the potential level conversion by the level shifting circuit 53, the reference potential H_SIG_VSS is set to the gate-OFF potential VGL when the reference potential L_SIG_VSS is at a low level, and the reference potential H_SIG_VSS is set to the gate-ON potential VGH when the reference potential L_SIG_VSS is at a high level.

The source driver 32 and the gate driver 24 perform the same operations as in the first embodiment. With this, the driving video signal is applied to each of the source bus lines SL1 to SLj and the scanning signal is applied to each of the gate bus lines GL1 to GLi, and thus an image based on the image signal DAT supplied externally is displayed in the display unit 22.

In this embodiment, a power-supply condition detecting unit is realized by the power-OFF detecting unit 57, and the reference potential generating unit and the clock signal generating unit are realized by the timing controller 51 and the level shifting circuit 53.

The shift register 240 and the bistable circuits are configured in the same manner as in the first embodiment (see FIG. 6 and FIG. 8). Accordingly, the operations of the shift register 240 and the bistable circuits are the same as in the first embodiment (see FIG. 7 and FIG. 9).

<2.2 Method for Changing Reference Potential>

In the first embodiment, the level of the reference potential H_SIG_VSS supplied to the reference potential line is switched between the gate-OFF potential VGL and the gate-ON potential VGH using the reference potential switching circuit 19 configured by such as a transistor. Specifically, in the first embodiment, the configuration for increasing the level of the reference potential H_SIG_VSS when the supply of the power-supply voltage PW is cut off is realized by an analog method. By contrast, in this embodiment, the configuration for increasing the level of the reference potential H_SIG_VSS is realized by a digital method. This will be described below.

During the time period in which the power-supply voltage PW is normally supplied, the power-supply condition signal SHUT outputted from the power-OFF detecting unit 57 is set to low level. With this, the reference potential L_SIG_VSS supplied from the timing controller 51 to the level shifting circuit 53 is at low level. Here, as described above, in the potential level conversion by the level shifting circuit 53, the reference potential H_SIG_VSS is set to the gate-OFF potential VGL when the reference potential L_SIG_VSS is at a low level. Accordingly, during the time period in which the power-supply voltage PW is normally supplied, the reference potential H_SIG_VSS supplied to the reference potential line is set to the gate-OFF potential VGL.

When the supply of the power-supply voltage PW is cut off, the power-supply condition signal SHUT outputted from the power-OFF detecting unit 57 is set to high level. With this, the reference potential L_SIG_VSS supplied from the timing controller 51 to the level shifting circuit 53 is at high level. Here, as described above, in the potential level conversion by the level shifting circuit 53, the reference potential H_SIG_VSS is set to the gate-ON potential VGH when the reference potential L_SIG_VSS is at a high level. Accordingly, the reference potential H_SIG_VSS outputted from the level shifting circuit 53 changes from the gate-OFF potential VGL to the gate-ON potential VGH. In this manner, when the supply of the power-supply voltage PW is cut off, the reference potential H_SIG_VSS supplied to the reference potential line is set to the gate-ON potential VGH.

Here, when the supply of the power-supply voltage PW is cut off, similarly to the first embodiment, the first gate clock signal H_CK1 and the second gate clock signal H_CK2 are set to the gate-ON potential VGH. Specifically, when the supply of the power-supply voltage PW is cut off, similarly to the first embodiment, the reference potential H_SIG_VSS, the first gate clock signal H_CK1, and the second gate clock signal H_CK2 are set to the gate-ON potential VGH (see FIG. 1).

<2.3 Effects>

According to this embodiment, similarly to the first embodiment, when the external supply of the power-supply voltage PW is cut off, the gate bus lines and the reference potential line are electrically connected, and the level of the reference potential VSS is increased from the gate-OFF potential VGL to the gate-ON potential VGH. With this, the gate bus lines are turned to the selected state, and the residual charges of the pixel formation portions are quickly discharged. As a result, lowering of the visual quality due to residual charges accumulated within the pixel formation portions is suppressed.

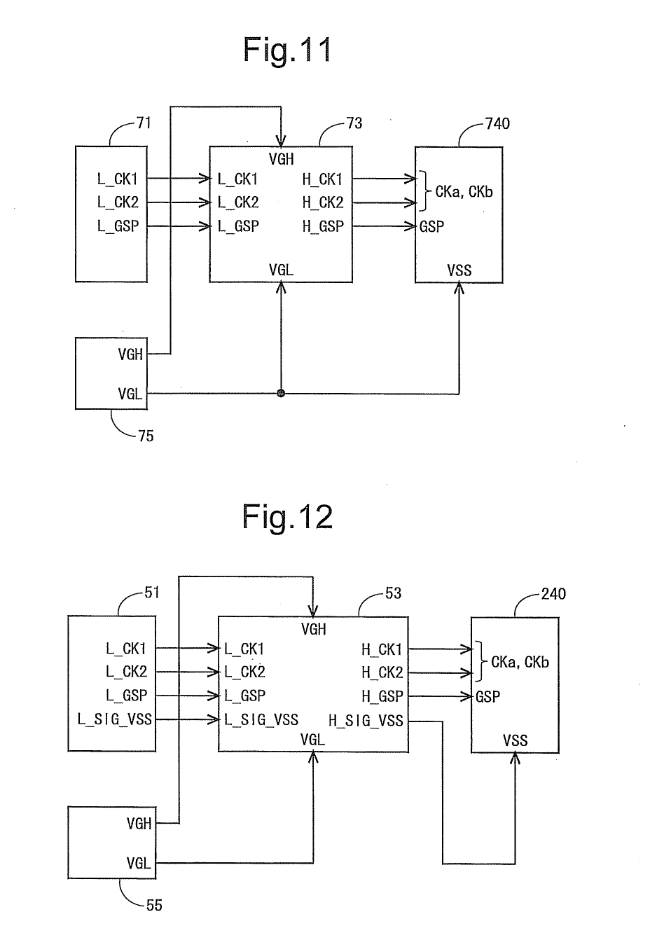

Further, according to this embodiment, a liquid crystal display device capable of quickly eliminating residual charges within the pixel formation portions when the power is turned off can be realized at relatively low cost. This will be described below. According to the conventional configuration, as illustrated in FIG. 11, for example, the gate-OFF potential VGL outputted from a power-supply circuit 75 is supplied as the reference potential VSS to a shift register 740. Moreover, in a gate driver monolithic panel, in order to obtain relatively high voltage within the panel, it is necessary to provide a level shifting circuit 73 outside the panel as illustrated in FIG. 11. According to such a conventional configuration, the reference potential VSS supplied to the shift register 740 is fixed potential. In this case, even when the thin-film transistors TD and TM illustrated in FIG. 8 are turned to the ON state, it is not possible to increase the potential of the state signal Q outputted from each bistable circuit. Thus, in this embodiment, as illustrated in FIG. 12, the configuration is such that the output signal H_SIG_VSS outputted from the level shifting circuit 53 is supplied to the shift register 240 as the reference potential VSS. With such a configuration, it is possible to easily make the level of the reference potential VSS supplied to the shift register 240 variable, and to increase the potential of the state signal Q outputted from each bistable circuit when the thin-film transistors TD and TM are in the ON state. Here, as described above, in a gate driver monolithic panel, a level shifting circuit is conventionally provided outside the panel. Therefore, it is not necessary to increase the number of circuit components and such even when the configuration is such that an output signal from a level shifting circuit is used for the reference potential. Accordingly, a liquid crystal display device capable of quickly eliminating residual charges within the pixel formation portions can be realized at low cost. Further, since it is possible to perform digital processing by using level shifting circuit, controlling of the circuits can be facilitated.

<2.4 Modified Examples>

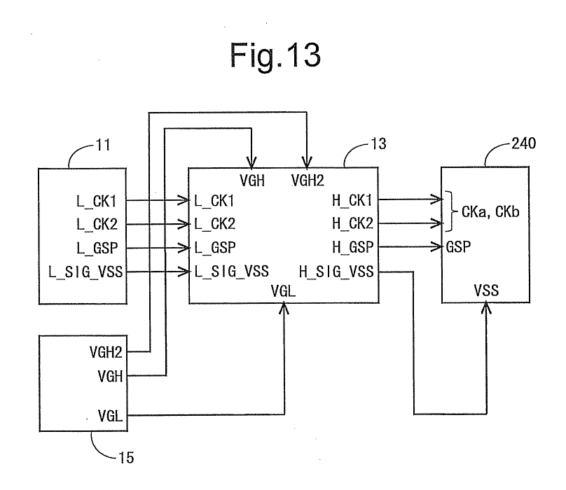

According to the second embodiment, the configuration is such that the level of the reference potential VSS supplied to the shift register 240 is increased from the gate-OFF potential VGL to the gate-ON potential VGH when the supply of the power-supply voltage PW is cut off. However, the present invention is not limited to this. For example, in a case in which a potential of the auxiliary capacitance electrode 223 (see FIG. 3) is set to be a relatively high potential, when the supply of the power-supply voltage PW is cut off, a drain potential of the thin-film transistor 220 within the pixel formation portion largely decreases. Therefore, it can be turned to the ON state even if the potential supplied to the gate bus lines is lower than the gate-ON potential VGH. Thus, as illustrated in FIG. 13, it is possible to employ an configuration in which a second gate-ON potential VGH2 (e.g., 10 V) lower than the gate-ON potential VGH (e.g., 22 V) is supplied from the power-supply circuit 15 to the level shifting circuit 13, so that the level of the reference potential VSS supplied to the shift register 240 is increased from the gate-OFF potential VGL to the second gate-ON potential VGH2 when the supply of the power-supply voltage PW is cut off.

### 3. Other Configurations

<3.1 Phase Number of Clock Signal>

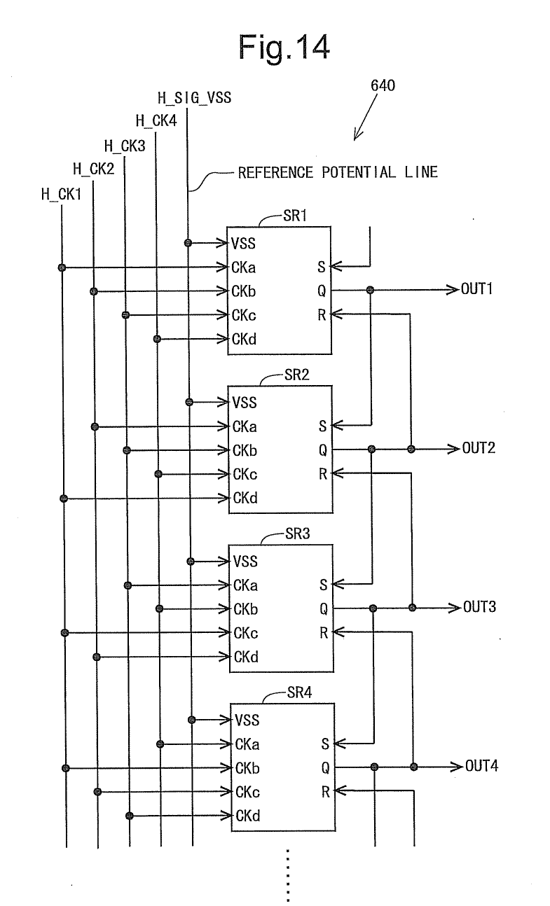

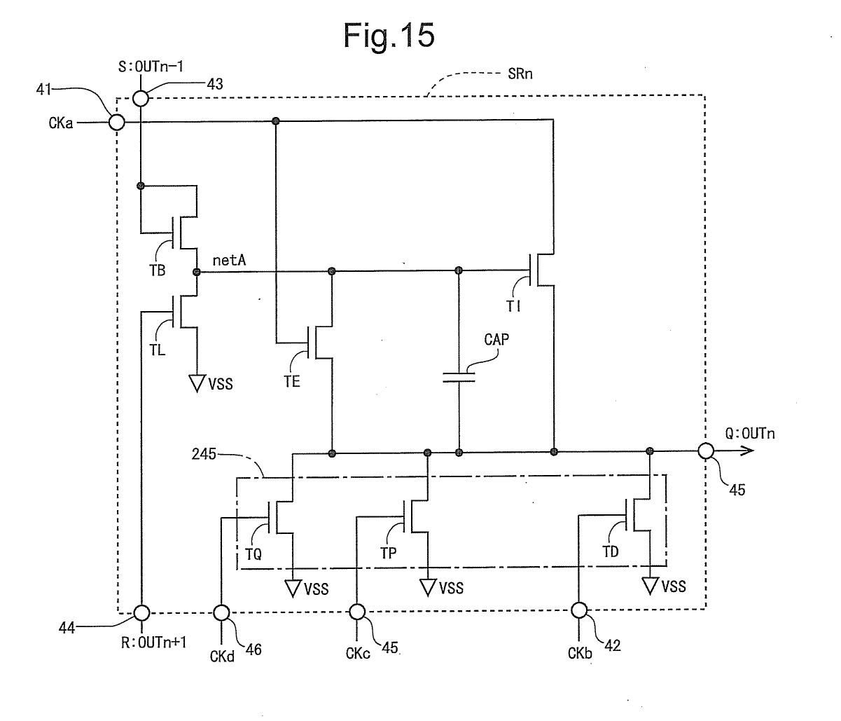

According to the embodiments described above, the shift register 240 operates based on two-phase clock signals. However, the number of phases of the clock signal is not limited to two. In the following, an example of applying the present invention to a liquid crystal display device provided with a shift register 640 operating based on four-phase clock signals is described. FIG. 14 is a block diagram illustrating an example of a configuration of the shift register 640 operating based on four-phase clock signals. Here, FIG. 14 shows a configuration of bistable circuits SR1 to SR4 of a first stage to fourth stage of the shift register 640. Each bistable circuit is provided with, in addition to the input/output terminals according to the first embodiment, an input terminal for receiving a third clock CKc and an input terminal for receiving a fourth clock CKd. First to fourth gate clock signals H_CK1 to H_CK4 transmitted to the shift register 640 are supplied to each bistable circuit as illustrated in FIG. 14. FIG. 15 is a circuit diagram illustrating a configuration of each bistable circuit included in the shift register 640. In the first embodiment, the potential level maintaining unit 241 for maintaining the potential of the state signal Q at a low level is realized by the AND circuit 242, the thin-film transistor TM, and the thin-film transistor TD (see FIG. 8). By contrast, according to the configuration illustrated in FIG. 15, a potential level maintaining unit 245 is realized by the thin-film transistor TD configured in the same manner as in the first embodiment, a thin-film transistor TP whose gate terminal is supplied with the third clock CKc, and a thin-film transistor TQ whose gate terminal is supplied with the fourth clock CKd.

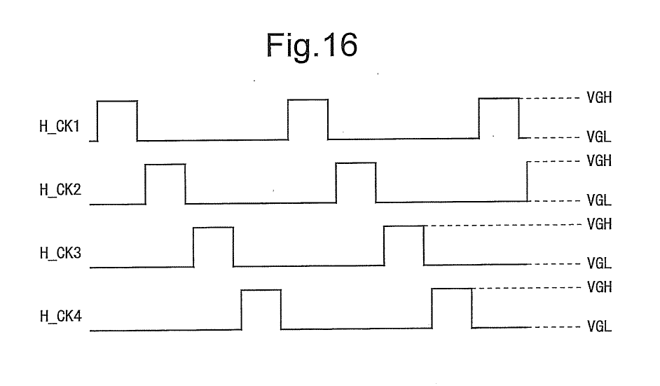

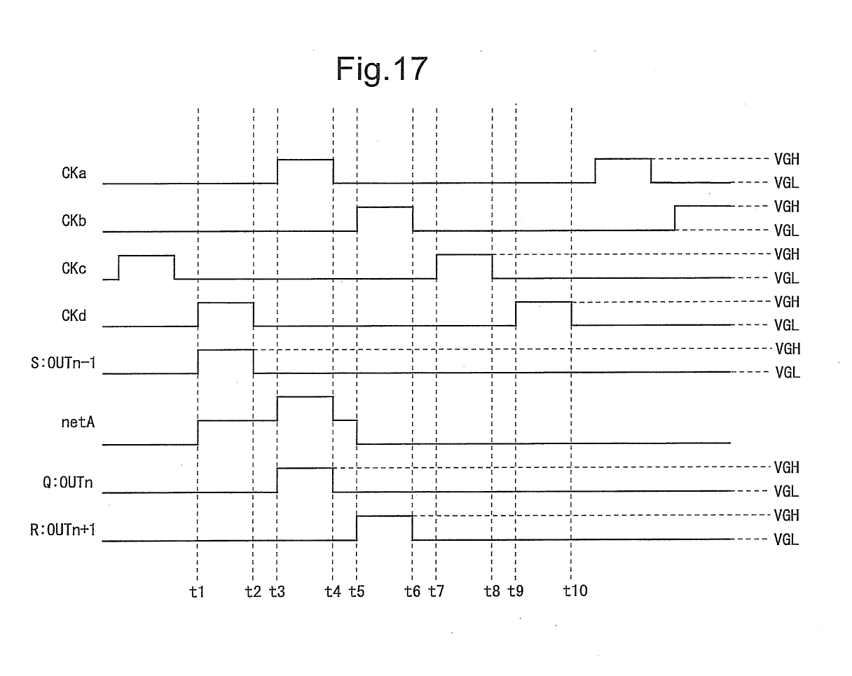

In the above configuration, the first to fourth gate clock signals H_CK1 to H_CK4 having waveforms as illustrated in FIG. 16 are supplied to the shift register 640. With this, each bistable circuit operates as described below (see FIG. 17).

When the set signal S changes from level low to high level at the time point t1, the thin-film transistor TB is turned to the ON state, and the potential of the netA changes from low level to high level. This turns the thin-film transistor TI to the ON state. After the set signal S changes from high level to low level at the time point t2, when reaching the time point t3, the first clock CKa changes from low level to high level. With this, the potential of the netA is increased due to the bootstrap effect of the capacitor CAP, and a high voltage is applied to the gate terminal of the thin-film transistor TI. As a result, the potential of the state signal Q becomes the gate-ON potential VGH. At the time point t4, when the first clock CKa changes from high level to low level, the potential of the state signal Q and the potential of the netA decrease. At the time point t5, when the reset signal R and the second clock CKb change from low level to high level, the thin-film transistor TL and the thin-film transistor TD are turned to the ON state, and the potential of the netA and the potential of the state signal Q become low. After the second clock CKb changes from high level to low level at a time point t6, when reaching a time point t7, the third clock CKc changes from low level to high level. With this, the thin-film transistor TP is turned to the ON state, and the potential of the state signal Q is pulled to the reference potential VSS. After the third clock CKc changes from high level to low level at a time point t8, when reaching a time point t9, the fourth clock CKd changes from low level to high level. With this, the thin-film transistor TQ is turned to the ON state, and the potential of the state signal Q is pulled to the reference potential VSS.

Here, when the external supply of the power-supply voltage PW is cut off, all of the first to fourth gate clock signals H_CK1 to H_CK4 are set to high. With this, in each bistable circuit, the thin-film transistor TD, the thin-film transistor TP, and the thin-film transistor TQ are turned to the ON state. Further, similarly to the first embodiment and the second embodiment, the level of the reference potential VSS is increased from the gate-OFF potential VGL to the gate-ON potential VGH. With this, the potential of the state signal Q outputted from each bistable circuit is increased, and the residual charges of the pixel formation portions are quickly discharged. In this manner, it is possible to apply the present invention to the liquid crystal display device provided with the shift register 640 operating based on four-phase clock signals.

Regarding the liquid crystal display device provided with the shift register operating based on four-phase clock signals, it is also possible to apply the present invention to a liquid crystal display device provided with a shift register configured such that odd-number-th stages operate based on the first gate clock signal H_CK1 and the third gate clock signal H_CK3 having waveforms illustrated in FIG. 16, and such that even-number-th stages operate based on the second gate clock signal H_CK2 and the fourth gate clock signal H_CK4 having waveforms illustrated in FIG. 16.

<3.2 Method of Realizing Drive Circuit>

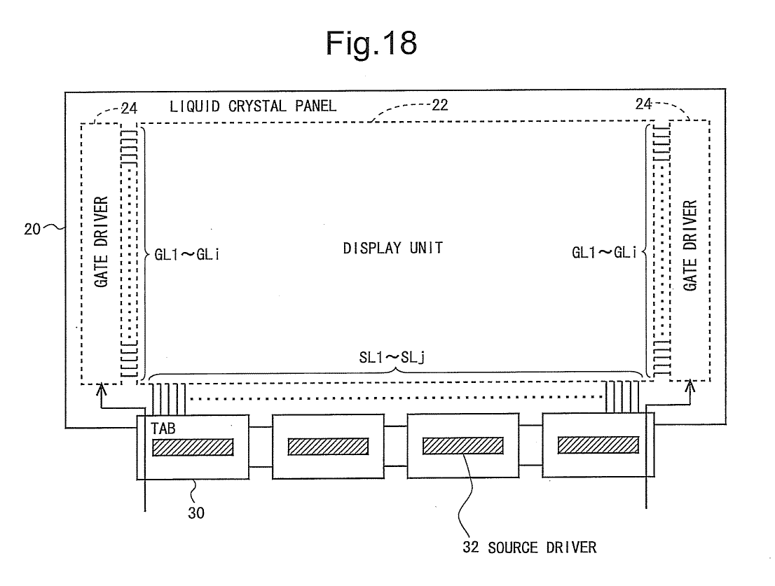

In the embodiments described above, the description is given taking the example of the liquid crystal display device configured such that the gate driver 24 is provided only on one side of the display unit 22 (right side in FIG. 2 and FIG. 10). However, the present invention is not limited to this. The present invention can be applied to a liquid crystal display device provided with the gate driver 24 on either side of the display unit as illustrated in FIG. 18 (left and right sides in FIG. 18).

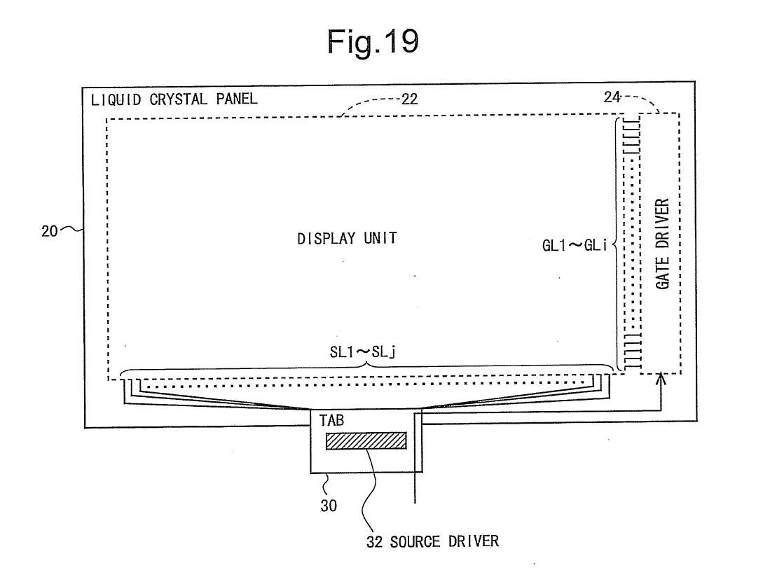

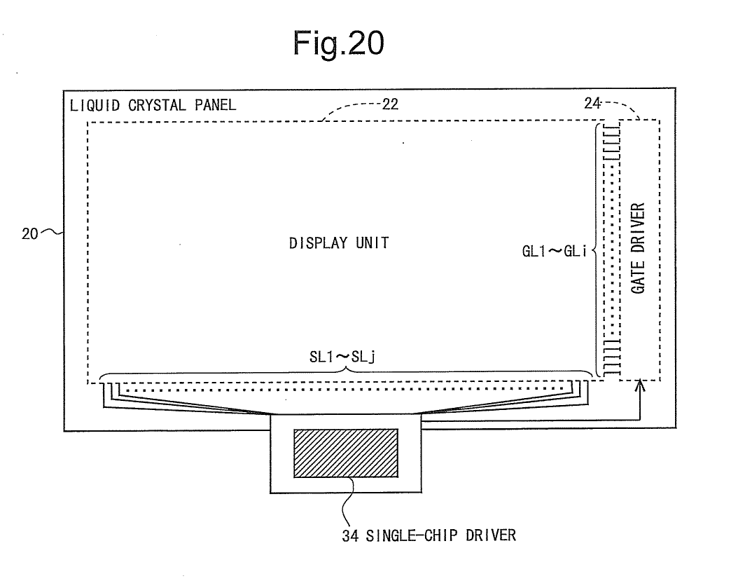

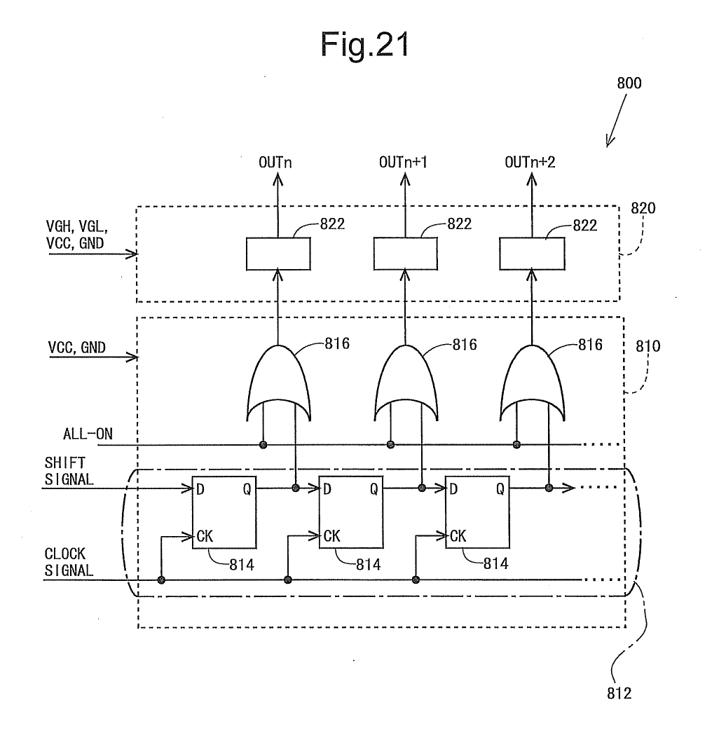

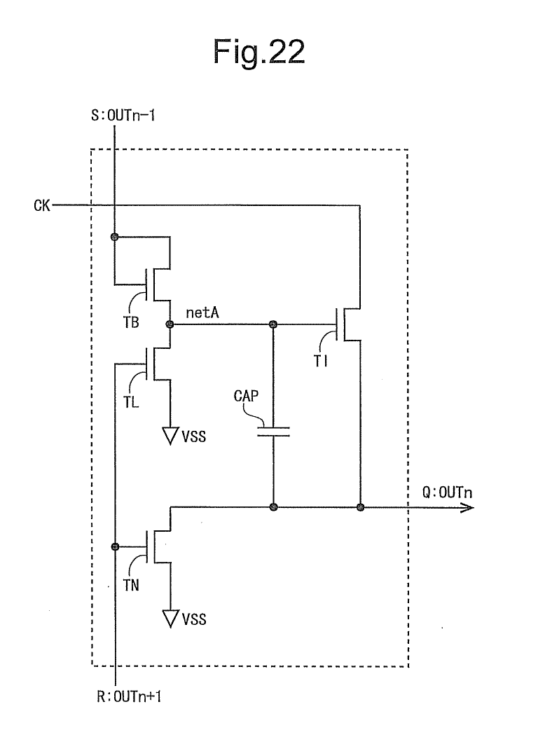

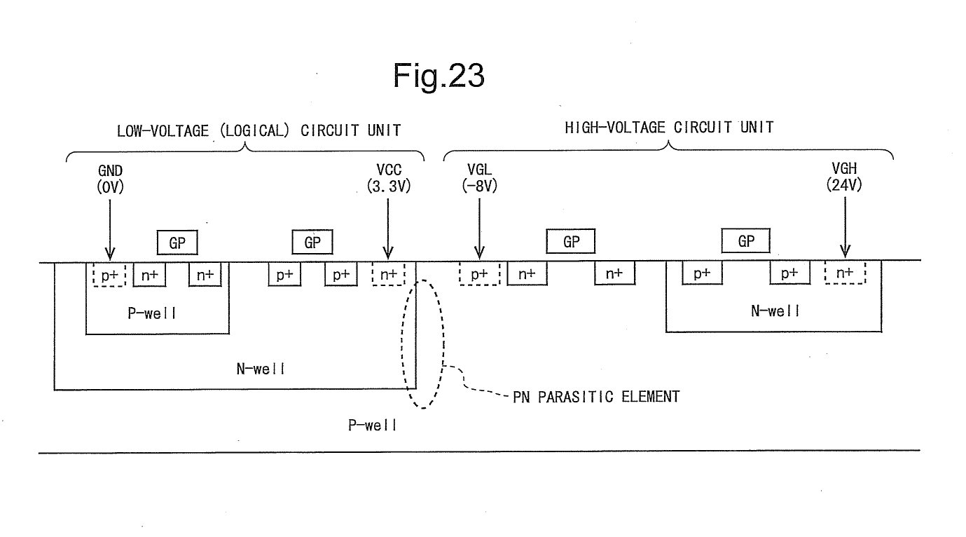

Further, according to the embodiments described above, the description is given taking the example of the liquid crystal display device in which the source driver 32 is configured by the plurality of IC chips. However, the present invention is not limited to this. The present invention can be applied to a liquid crystal display device in which the source driver 32 is configured by a single IC chip as illustrated in FIG. 19. Additionally, the present invention can also be applied to a liquid crystal display device having a so-called single-chip driver in which not only the source driver 32 but also the timing controller 11, the level shifting circuit 13, the power-supply circuit 15, the power-OFF detecting unit 17, and the reference potential switching circuit 19 according to the first embodiment, for example, are included in a single IC chip (see FIG. 20).

Moreover, the configuration of the shift register 240 is not limited to that shown in FIG. 6 or FIG. 14, and the specific configuration of each bistable circuit in the shift register 240 is not limited to that shown in FIG. 8 or FIG. 16.

### DESCRIPTION OF REFERENCE CHARACTERS

11, 51 timing controller

13, 53 level shifting circuit

15, 55 power-supply circuit

17, 57 power-OFF detecting unit

19 reference potential switching circuit

20 liquid crystal panel

22 display unit

24 gate driver (scanning signal line drive circuit)

32 source driver (video signal line drive circuit)

220 thin-film transistor (within pixel formation portion)

240, 640 shift register

241, 245 potential level maintaining unit

PW power-supply voltage

SHUT power-supply condition signal

VGH gate-ON potential

VGL gate-OFF potential

L_CK1, H_CK1 first gate clock signal

L_CK2, H_CK2 second gate clock signal

L_SIG_VSS, H_SIG_VSS, VSS reference potential

TB, TD, TE, TI, TL, TM, TN, TP, TQ thin-film transistor (within bistable circuit)

CKa first clock

CKb second clock

S set signal

R reset signal

Q state signal

1. A liquid crystal display device comprising:
a plurality of video signal lines respectively for transmitting a plurality of video signals representing an image to be displayed;
a plurality of scanning signal lines intersecting with the plurality of video signal lines;
a plurality of pixel formation portions arranged in matrix respectively corresponding to intersections between the plurality of video signal lines and the plurality of scanning signal lines, each pixel formation portion including a first switching element and a pixel electrode, the first switching element having a control terminal connected to the scanning signal line passing through the corresponding intersection and a first conductive terminal connected to the video signal line passing through the corresponding intersection, the pixel electrode being connected to a second conductive terminal of the first switching element;
a scanning signal line drive circuit including a shift register configured by a plurality of bistable circuits which are provided so as to have a one-to-one corresponding with the plurality of scanning signal lines, the shift register sequentially outputting a pulse based on a clock signal that cyclically repeats a first potential and a second potential, the scanning signal line drive circuit being configured to selectively drive the plurality of scanning signal lines based on the pulse outputted from the shift register and being formed on the same substrate as the substrate on which the plurality of scanning signal lines are formed;
a power-supply condition detecting unit configured to detect ON/OFF state of power-supply that is given externally;
a reference potential generating unit configured to generate a reference potential of the plurality of bistable circuits; and
a reference potential line for transmitting the reference potential generated by the reference potential generating unit to the plurality of bistable circuits, wherein
each bistable circuit includes a potential level maintaining unit for electrically connecting the corresponding scanning signal line with the reference potential line such that a potential level of the corresponding scanning signal line is maintained at the level of the reference potential during a time period in which the corresponding scanning signal line is in an unselected state, and
when the OFF state of the power-supply is detected by the power-supply condition detecting unit,
the potential level maintaining unit included in each bistable circuit electrically connects the scanning signal line corresponding to the bistable circuit with the reference potential line, and
the reference potential generating unit increasing the level of the reference potential up to a level at which the first switching element becomes conductive.

2. The liquid crystal display device according to claim 1, further comprising:
a clock signal generating unit configured to generate the clock signal, wherein
the potential level maintaining unit included in each bistable circuit includes a second switching element having a first conductive terminal connected to the reference potential line, a second conductive terminal connected to the scanning signal line corresponding to the bistable circuit, and a control terminal to which the clock signal is supplied, and
when the OFF state of the power-supply is detected by the power-supply condition detecting unit, the clock signal generating unit sets the clock signal to the first potential or the second potential such that the second switching element included in each bistable circuit becomes conductive.

3. The liquid crystal display device according to claim 2, wherein
the potential level maintaining unit included in each bistable circuit includes a plurality of the second switching elements,
the clock signal generating unit generates a plurality of the clock signals to be respectively supplied to control terminals of the plurality of second switching elements included in each potential level maintaining unit, and
when the OFF state of the power-supply is detected by the power-supply condition detecting unit, the clock signal generating unit sets the plurality of clock signals to the first potential or the second potential respectively such that the plurality of second switching elements included in each potential level maintaining unit become conductive.

4. The liquid crystal display device according to claim 1, wherein
the reference potential generating unit includes a level shifting circuit configured to convert a potential level of a predetermined inputted signal, thereby supplying a predetermined high level potential or a predetermined low level potential to the reference potential line, and
the level shifting circuit supplies:
the low level potential to the reference potential line as the reference potential, when the OFF state of the power-supply is not detected by the power-supply condition detecting unit, and
the high level potential to the reference potential line as the reference potential, when the OFF state of the power-supply is detected by the power-supply condition detecting unit.

5. A method of driving a liquid crystal display device,
the liquid crystal display device provided with: a plurality of video signal lines respectively for transmitting a plurality of video signals representing an image to be displayed; a plurality of scanning signal lines intersecting with the plurality of video signal lines; a plurality of pixel formation portions arranged in matrix respectively corresponding to intersections between the plurality of video signal lines and the plurality of scanning signal lines, each pixel formation portion including a first switching element and a pixel electrode, the first switching element having a control terminal connected to the scanning signal line passing through the corresponding intersection and a first conductive terminal connected to the video signal line passing through the corresponding intersection, the pixel electrode being connected to a second conductive terminal of the first switching element; and a scanning signal line drive circuit formed on the same substrate as the substrate on which the plurality of scanning signal lines are formed and including a shift register configured by a plurality of bistable circuits which are provided so as to have a one-to-one corresponding with the plurality of scanning signal lines, the shift register sequentially outputting a pulse based on a clock signal that cyclically repeats a first potential and a second potential, the scanning signal line drive circuit being configured to selectively drive the plurality of scanning signal lines based on the pulse outputted from the shift register, the method comprising:
a power-supply condition detecting step of detecting ON/OFF state of power-supply that is given externally; and
a reference potential generating step of generating a reference potential of the plurality of bistable circuits, wherein
the liquid crystal display device is further provided with a reference potential line for transmitting the reference potential generated in the reference potential generating step to the plurality of bistable circuits, and
when the OFF state of the power-supply is detected in the power-supply condition detecting step,
the scanning signal line corresponding to each bistable circuit and the reference potential line are electrically connected, and
the level of the reference potential is increased up to a level at which the first switching element becomes conductive in the reference potential generating step.

6. The method of driving according to claim 5, further comprising:
a clock signal generating step of generating the clock signal, wherein
each bistable circuit includes a second switching element having a first conductive terminal connected to the reference potential line, a second conductive terminal connected to the scanning signal line corresponding to the bistable circuit, and a control terminal to which the clock signal is supplied, and
when the OFF state of the power-supply is detected in the power-supply condition detecting step, the clock signal is set to the first potential or the second potential such that the second switching element included in each bistable circuit becomes conductive in the clock signal generating step.

7. The method of driving according to claim 6, wherein
each bistable circuit includes a plurality of the second switching elements,
a plurality of the clock signals to be respectively supplied to control terminals of the plurality of second switching elements included in each bistable circuit are generated in the clock signal generating step, and
when the OFF state of the power-supply is detected in the power-supply condition detecting step, the plurality of clock signals are set to the first potential or the second potential such that the plurality of second switching elements included in each bistable circuit become conductive in the clock signal generating step.

8. The method of driving according to claim 5, further comprising:
a level converting step of converting a potential level of a predetermined inputted signal to supply a predetermined high level potential or a predetermined low level potential to the reference potential line, and
in the level converting step,
when the OFF state of the power-supply is not detected in the power-supply condition detecting step, the potential level of the inputted signal is converted to the low level potential, and
when the OFF state of the power-supply is detected in the power-supply condition detecting step, the potential level of the inputted signal is converted to the high level potential.
